(19) United States
(12) Patent Application Publication
(10) Pub. No.: US 2023/0420652 A1
(43) Pub. Date: Dec. 28, 2023

(54) PROCESS FOR MAKING AN ELECTRODE ACTIVE MATERIAL

(71) Applicant: BASF SE, Ludwigshafen (DE)

(72) Inventors: Benjamin Johannes Herbert BERGNER, Ludwigshafen (DE); Pascal HARTMANN, Ludwigshafen (DE)

(21) Appl. No.: 18/253,475

(22) PCT Filed: Nov. 29, 2021
(86) PCT No.: PCT/EP2021/083359

§ 371 Date: May 18, 2023

(30) Foreign Application Priority Data
Dec. 8, 2020 (EP) 20212552.2

(51) Int. Cl. H01M 4/36; C01G 53/00; H01M 4/525; H01M 4/505; H01M 4/62; H01M 4/48

(52) U.S. Cl. CPC H01M 4/364; C01G 53/44; H01M 4/525; H01M 4/505; H01M 4/625; H01M 4/48; C01P 2006/40; C01P 2004/04; C01P 2002/85; H01M 2004/028

(57) ABSTRACT

Disclosed herein is a process for making an electrode active material, where said process includes the following steps:
(a) providing an (oxy)hydroxide or oxide of TM, where TM is a combination of metals, and where TM contains Ni and at least one of Mn and Co;
(b) treating said oxide or (oxy)hydroxide from step (a) with a non-aqueous or aqueous solution of a compound of M2, where M2 is selected from the group consisting of Ti, Zr, Nb, and Ta;
(c) removing the solvent(s), thereby obtaining a solid residue;
(d) mixing the solid residue from step (c) with a source of lithium and, optionally, at least one compound of Ti or Al or Zr; and
(e) treating the mixture obtained from step (d) thermally at a temperature in the range of from 550 to 900° C.

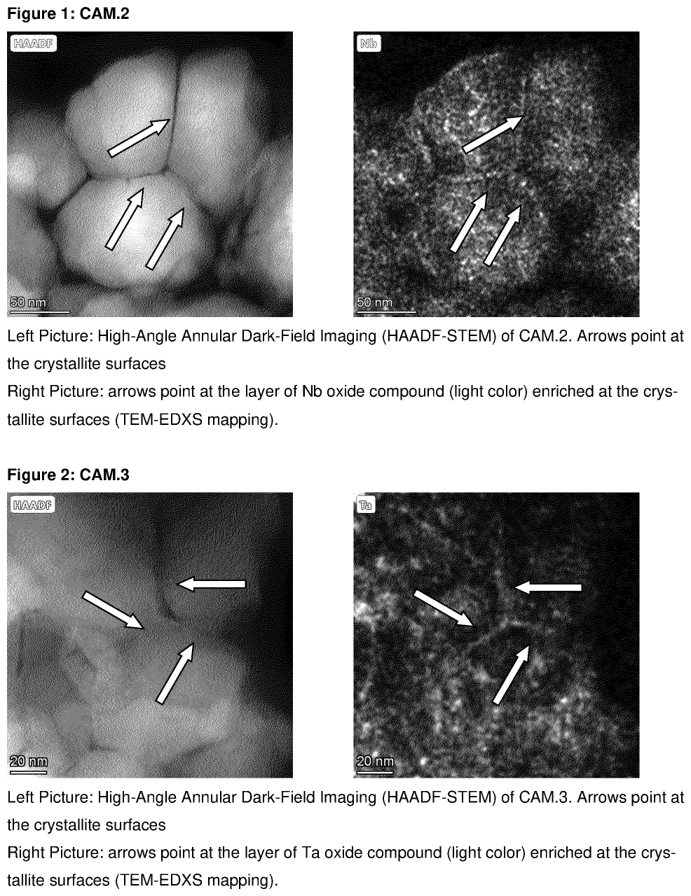

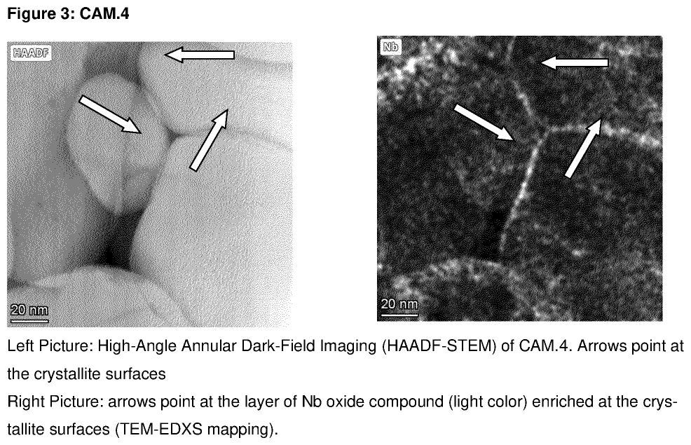

The present invention is directed towards a process for making an electrode active material wherein said process comprises the following steps:
(a) Providing an (oxy)hydroxide or oxide of TM wherein TM is nickel or a combination of metals wherein TM contains Ni and at least one of Mn and Co,
(b) treating said oxide or (oxy)hydroxide from step (a) with a non-aqueous or aqueous solution of a compound of M² wherein M² is selected from Ti, Zr, Nb or Ta,
(c) removing the solvent(s), thereby obtaining a solid residue,
(d) mixing the solid residue from step (c) with a source of lithium and, optionally, at least one compound of Ti or Al or Zr,
(e) treating the mixture obtained from step (d) thermally at a temperature in the range of from 550 to 900° C.

Lithium ion secondary batteries are modern devices for storing energy. Many application fields have been and are contemplated, from small devices such as mobile phones and laptop computers through car batteries and other batteries for e-mobility. Various components of the batteries have a decisive role with respect to the performance of the battery such as the electrolyte, the electrode materials, and the separator. Particular attention has been paid to the cathode materials. Several materials have been suggested, such as lithium iron phosphates, lithium cobalt oxides, and lithium nickel cobalt manganese oxides. Although extensive research has been performed the solutions found so far still leave room for improvement.

The electrode material is of crucial importance for the properties of a lithium ion battery. Lithium-containing mixed transition metal oxides have gained particular significance, for example spinels and mixed oxides of layered structure, especially lithium-containing mixed oxides of nickel, manganese and cobalt; see, for example, EP 1 189 296. However, not only the stoichiometry of the electrode material is important, but also other properties such as morphology and surface properties.

In a typical process for making cathode materials for lithium-ion batteries, first a so-called precursor is being formed by co-precipitating the transition metals as carbonates, oxides or preferably as hydroxides that may or may not be basic, for example oxyhydroxides. The precursor is then mixed with a source of lithium such as, but not limited to LiOH, Li₂O or Li₂CO₃ and calcined (fired) at high temperatures. Lithium salt(s) can be employed as hydrate(s) or in dehydrated form. The calcination—or firing—often also referred to as thermal treatment or heat treatment of the precursor—is usually carried out at temperatures in the range of from 600 to 1,000° C.

During the thermal treatment a solid-state reaction takes place, and the electrode active material is formed. The thermal treatment is performed in the heating zone of an oven or kiln.

Existing lithium ion batteries still have potential for improvement, especially with regard to the to energy density and cycling stability. While the low cycling stability is often ascribed to side reactions on the surface of the cathode active material (CAM) it has been found that coatings—that may reduce the side reactions—create a resistance for Li⁺ cations. It was therefore an objective of the present invention to provide a cathode active material that overcomes the above disadvantages, and a process for manufacturing the same.

A typical class of cathode active materials delivering high energy density contains a high amount of Ni (Ni-rich), for example at least 80 mol-%, referring to the content of non-lithium metals. However, the energy density still needs improvement.

It was therefore an objective of the present invention to provide precursors for electrode active materials with high energy density and a simple process for manufacturing them.

Accordingly, the process defined at the outset has been found, hereinafter also referred to as “inventive process”. The inventive process comprises the following steps:
wherein said process comprises the following steps:
(a) Providing an (oxy)hydroxide or oxide of TM wherein TM is a combination of metals and wherein TM contains Ni and at least one of Mn and Co,
(b) treating said oxide or (oxy)hydroxide from step (a) with a non-aqueous or aqueous solution of a compound of M² wherein M² is selected from Ti, Zr, Nb or Ta,
(c) removing the solvent(s), thereby obtaining a solid residue,
(d) mixing the solid residue from step (c) with a source of lithium and, optionally, at least one compound of Ti or Al or Zr,
(e) treating the mixture obtained from step (d) thermally at a temperature in the range of from 550 to 900° C.

The inventive process comprises at least five steps, (a), (b), (c), (d), and (e), in the context of the present invention also referred to as step (a) and step (b) and step (c) and step (d) and step (e), respectively. Optionally, the inventive process additionally a step (e) or (f) described further below, or both. Steps (a) to (d) as well as the optional steps (e) and (f) shall be described in more detail below.

The inventive process starts off from an (oxy)hydroxide of TM or an oxide of TM. In such (oxy)hydroxide or oxide of TM, TM is a combination of at least two metals and contains Ni and at least one of Mn and Co. Preferably, TM contains Ni and both Co and Mn.

TM may include of at least one metal selected from Al, Ti, Zr, V, Zn, Ba, and Mg. Preferably, TM contains in total up to 0.5 mol-% of at least one metal selected from Al, Ti, and Zr, and only traces of V, Zn, Ba, and Mg. The amount and kind of metals such as Ti, Zr, V, Co, Zn, Ba, and Mg may be determined by inductively coupled plasma (“ICP”) and by synchrotron XRD.

In one embodiment of the present invention, TM is a combination of metals according to general formula (I)

(NiₐCo_{b}Mn_{c})_{1-d}M_{d} (I)

with
a being in the range of from 0.6 to 0.99,
b being zero or in the range of from 0.01 to 0.2,
c being in the range of from zero to 0.2, and
d being in the range of from zero to 0.1,
M is at least one of Al, Mg, Ti, Mo, and W, and
b+c>zero, and
a+b+c=1.

Said (oxy)hydroxide or oxide of TM provided in step (a) is preferably comprised of spherical particles, referring to particles that have a spherical shape. Spherical particles shall include not just those which are exactly spherical but also those particles in which the maximum and minimum diameter of at least 90% (number average) of a representative sample differ by not more than 10%.

In one embodiment of the present invention, said (oxy)hydroxide or oxide of TM provided in step (a) is comprised of secondary particles that are agglomerates of primary particles. Preferably, said (oxy)hydroxide or oxide of TM provided in step (a) is comprised of spherical secondary particles that are agglomerates of primary particles. Even more preferably, said (oxy)hydroxide or oxide of TM provided in step (a) is comprised of spherical secondary particles that are agglomerates of spherical primary particles or platelets.

In one embodiment of the present invention, said (oxy)hydroxide or oxide of TM provided in step (a) has an average particle diameter (D50) in the range of from 3 to 20 μm, preferably from 5 to 16 μm. The average particle diameter can be determined, e. g., by light scattering or LASER diffraction or electroacoustic spectroscopy. The particles are usually composed of agglomerates from primary particles, and the above particle diameter refers to the secondary particle diameter.

Some elements are ubiquitous. In the context of the present invention, traces of ubiquitous metals such as sodium, calcium, iron or zinc, as impurities will not be taken into account in the description of the present invention. Traces in this context will mean amounts of 0.02 mol-% or less, referring to the total metal content of TM.

Said (oxy)hydroxide or oxide of TM as provided in step (a) may contain traces of anions other than oxide and hydroxide, for example carbonate and sulfate. Especially when said (oxy)hydroxide or oxide of TM is manufactured from sulfates of TM, some residual sulfate may remain in the precipitate. Carbonate may be included by the use of aged alkali hydroxide or by exposing the freshly precipitated TM(OH)₂ to air that contains CO₂.

(Oxy)hydroxide or oxide of TM as provided in step (a) may be manufactured by co-precipitation of Ni and at least one of Co and Mn and, optionally, further metals, as hydroxide of TM with alkali metal hydroxide from an aqueous solution of nickel sulfate that is combined with a sulfate of cobalt or manganese or with both and, if desired, at least one compound of metal(s) selected from Al, Ti, Zr, V, Co, Zn, or Ba, followed by filtration and drying.

Oxyhydroxide of TM as provided in step (a) may be manufactured by heating such hydroxide and thus removing water, for example to temperature in the range of 80 to 150° C., under vacuum or under air. Oxyhydroxide of TM is meant to include non-stoichiometric oxyhydroxides, with water bound chemically as hydroxide or with residual moisture content. In one embodiment of the present invention, said oxyhydroxide of TM has a moisture content in the range of from 50 to 2,000 ppm by weight. The moisture content in this case includes chemically and physically bound water and may be determined by Karl-Fischer titration.

(Oxy)hydroxide or oxide of TM as provided in step (a) may be dried at a temperature in the range of from 100 to 500° C., thereby obtaining an oxide or oxyhydroxide of TM with a moisture content in the range of from 50 to 2,000 ppm. Especially when TM contains significant amounts of manganese, a partial oxidation of TM and specifically of the manganese takes place, and the oxide is not strictly stoichiometric TMO.

The residual moisture content may be determined, e.g., by Karl-Fischer Titration.

In step (b), said oxide or (oxy)hydroxide from step (a) is treated with a non-aqueous or aqueous solution of a compound of M² wherein M² is selected from Ti, Zr, Nb or Ta, preferably M² is Nb or Ta and even more preferably M² is Nb. Combinations of two or more of the aforementioned are feasible as well.

Such compounds of M² may be selected from nitrates, sulfates, oxalates of M², for example Zr(SO₄)₂, ZrOSO₄, ZrO(NO₃)₂, NH₄)Nb(C₂O₄)₃, (NH₄)Ta(C₂O₄)₃, (NH₄)NbO(C₂O₄)₂, (NH₄)TaO(C₂O₄)₂ or the corresponding hydrates and preferably from C₁-C₄-alkanolates of M², for example methanolates, ethanolates, iso-propanolates, n-propanolates, n-butanolates, isobutanolates, sec.-butanolates, tert-butanolates, and mixed C₁-C₄-alkanolates of M². Non-limiting examples are Ti(OC₂H₅)₄, Zr(OC₂H₅)₄, Ti(O-isoC₃ Hz)₄, Zr(O-isoC₃ Hz)₄, Nb(OC₂H₅)₅, Ta(OC₂H₅)₅, Nb(O-isoC₃H₇)₅, Ta(O-isoC₃H₇)₅, Nb(O-nC₄H₉)₅, and Ta(O-nC₄H₉)₅. Combinations of at least two compounds of the aforementioned are possible as well.

Suitable solvents of such compounds of M² are selected from water and non-aqueous solvents such as alcohols and ethers, for example diethyl ether, di-n-butylether, di-isopropylether, 1,4-dioxane, tetrahydrofuran (THF), methanol, ethanol, iso-propanol, n-butanol, and mixtures of at least two of the aforementioned. Water and C₁-C₄-alcanolates are preferred. Preferred solvents of the C₁-C₄-alkanolates of M² are the corresponding alcohols.

Step (b) may be carried out by combining (oxy)hydroxide or oxide of TM with a solution of said compound of M², for example by adding a solution of said compound of M² to said (oxy)hydroxide or oxide of TM or vice versa.

In one embodiment of the present invention, the molar ratio of M² to TM is in the range of from 1:100 to 1:1000.

In one embodiment of the present invention, the volume ratio of said solution of M² to (oxy)hydroxide or oxide of TM is in the range of from 1:20 to 10:1.

Step (b) may be supported by a mixing operation, for example by stirring or shaking.

In one embodiment of the present invention, step (b) is performed at a temperature in the range of from 5° C. to 100° C., preferably at 10 to 40° C., more preferably at ambient temperature.

In one embodiment of the present invention, step (b) is performed under air or under an atmosphere of nitrogen or of a rare gas.

In one embodiment of the present invention, step (b) is commenced with a solvent selected from C₁-C₄-alcanolates, and in the course of step (b), water is added, for example by performing step (b) under an atmosphere of moist air or moist nitrogen, or by addition of liquid water.

In one embodiment of the present invention, step (b) is performed under a pressure of 0.1 bar to 100 bar, preferably between 0.5 bar and 10 bar.

In one embodiment of the present invention, step (b) has a duration of 1 minute to 2 hours, preferably for a duration of 2 minutes to 30 minutes.

In step (c), the solvent(s) are removed. Said removal refers to the solvent(s) from step (b) may be performed by a solid-liquid-separation method, for example by filtration or with the help of a centrifuge, or preferably by evaporation of the solvent(s).

In one embodiment of the present invention, the removal refers to organic solvent(s) as employed in step (b), and a complete or an almost complete removal of such solvents is preferred.

In this context, “almost complete” refers to at least 95 vol-% of the organic solvent( ) employed in step (b), preferably at least 98 vol-%. Even more preferably, 98.5 zo 99.9 vol-% of the organic solvent(s) employed in step (b) are removed.

In embodiments of water being solvent or the solvents, it is preferred to remove at least 50%, preferably at least 75% of the water, if applicable.

In one embodiment of the present invention, step (c) is performed by evaporation at a temperature in the range of from 10 to 150° C.

In one embodiment of the present invention, step (c) is performed by evaporation at a pressure in the range of from 10 to 500 mbar, preferred are 50 to 300 mbar.

In one embodiment of the present invention, step (c) is performed by filtration on a band filter or in a filter press, for example at ambient temperature.

By performing step (c), a solid residue is obtained.

Step (d) includes mixing the solid residue from step (c) with a source of lithium and, optionally, at least one compound of Ti or Al or Zr.

Examples of sources of lithium are inorganic compounds of lithium, for example LiNO₃, Li₂O, LiOH, Li₂O₂, Li₂CO₃, and combinations of at least two of the aforementioned, preference being given to Li₂O, LiOH and Li₂CO₃, water of crystallization being neglected in the context of the source of lithium, and even more preference being given to LiOH.

In one embodiment of the present invention, said source of lithium has an average particle diameter (D50) in the range of from 1 to 5 μm.

Suitable compounds of aluminum are, e.g., Al(NO₃)₃, Al₂O₃, Al(OH)₃, AlOOH, Al₂O₃-aq, preference being given to AlOOH and Al₂O₃, especially γ-Al₂O₃. Said source of aluminum may be added as aqueous solution, aqueous slurry or in particulate form, particulate form being preferred.

In one embodiment of the present invention, said compound of Al is particulate and has an average crystallite size determined by X-ray diffraction in the range of from 2 nm to 20 nm, preferably from 5 nm to 15 nm. The average particle diameter (D50) determined by dynamic laser scattering (DLS) is in the range from 1 to 10 μm, preferably from 1 to 3 μm.

Suitable compounds of Ti are TiO(OH)₂, Ti(OH)₄, TiO₂, TiO₂-aq, preferred is TiO₂.

In one embodiment of the present invention, said compound of Ti is particulate and has an average crystallite size determined by X-ray diffraction in the range of from 2 nm to 20 nm, preferably from 5 nm to 15 nm. The average particle diameter (D50) determined by dynamic laser scattering (DLS) is in the range from 1 to 10 μm, preferably from 1 to 3 μm.

Suitable compounds of Zr are Li₂ZrO₃, ZrO(OH)₂, Zr(OH)₄, ZrO₂, ZrO₂-aq, preferred are Zr(OH)₄, ZrO₂, and ZrO₂-aq, even more preferred is Zr(OH)₄.

In one embodiment of the present invention, said compound of Zr is particulate and has an average particle diameter (D50) crystallite size determined by X-ray diffraction in the range of from 2 nm to 20 nm, preferably from 5 nm to 15 nm. The average particle diameter (D50) determined by dynamic laser scattering (DLS) is in the range from 1 to 10 μm, preferably from 1 to 3 μm.

In one embodiment of the present invention, the molar ratio of source of lithium to (TM+Ti+Zr+Al) added in step (c) is in the range of from 1.05:1 to 1.0:1.

In embodiments where a in step (b), M² is selected from Ti o Zr it is preferred to not add a compound of Ti or Zr, respectively, in step (d).

In one embodiment of the present invention, the molar amount of Al added in step (d) is in the range of from 0.2 to 3 mol-%, referring to TM. In other embodiments, as indicated above, no compound of Al is added in step (d).

In one embodiment of the present invention, the molar amount of Ti added in step (d) is in the range of from 0.05 to 1 mol-%, referring to TM. In other embodiments, as indicated above, no compound of Ti is added in step (d).

In one embodiment of the present invention, the molar amount of Zr added in step (d) is in the range of from 0.05 to 1 mol-%, referring to TM. In other embodiments, as indicated above, no compound of Zr is added in step (d).

Step (d) may be performed as one operation but is preferred that step (d) comprises the substeps of mixing the residue from step (c) with said source of lithium followed by a sub-step of addition of a solution of source of magnesium. Said sub-steps shall be described in more detail below. It is preferred, though, to perform step (d) in one step or to first mix source of lithium with compound of magnesium or aluminum and with compound of Ti or Zr, sub-step (d1), followed by combination of the resultant mixture with oxide or oxyhydroxide of TM, sub-step (d2). In other embodiments, oxide or oxyhydroxide of TM are mixed with source of lithium and with compound of magnesium or aluminum and with compound of Ti or Zr in a single step.

Examples of suitable apparatuses for performing step (d) are high-shear mixers, tumbler mixers, plough-share mixers and free fall mixers.

Step (d) may be performed at any temperature in the range of from zero to 100° C., ambient temperature being preferred.

In one embodiment of the present invention, step (d) has a duration of 10 minutes to 2 hours. Depending on whether additional mixing is performed in step (d) or not, thorough mixing has to be accomplished in step (d).

Although it is possible to add an organic solvent, for example glycerol or glycol, or water in step (d) it is preferred to perform step (d) in the dry state, that is without addition of water or of an organic solvent.

A mixture is obtained from step (d).

Step (e) includes treating the mixture obtained from step (d) thermally at a temperature in the range of from 550 to 900° C.

Step (e) includes subjecting said mixture to heat treatment, for example at a temperature in the range of from 550 to 900° C., preferably 600 to 850° C., more preferably 650 to 825° C.

In one embodiment of the present invention, the mixture from step (e) is heated to 650 to 850° C. with a heating rate of 0.1 to 10° C./min.

In one embodiment of the present invention, the temperature is ramped up before reaching the desired temperature of from 600 to 850° C., preferably 650 to 825° C. For example, first the mixture from step (d) is heated to a temperature to 350 to 550° C. and then held constant for a time of 10 min to 4 hours, and then it is raised to 650° C. up to 850° C.

In embodiments wherein in step (d) at least one solvent has been used, as part of step (d), or separately and before commencing step (e), such solvent(s) are removed, for example by filtration, evaporation or distilling of such solvent(s). Preferred are evaporation and distillation.

In one embodiment of the present invention, step (e) is performed in a roller hearth kiln, a pusher kiln or a rotary kiln or a combination of at least two of the aforementioned. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well.

In one embodiment of the present invention, step (e) is performed in an oxygen-containing atmosphere, for example in pure oxygen or in oxygen-enriched air, for example in a 1:3 to 1:10 by volume mixture of air and oxygen, preference being given to pure oxygen.

By performing the inventive process, a cathode active material is made that shows excellent stability such as a low capacity fade and a high cycling stability.

A further aspect of the present invention is related to cathode active materials, hereinafter also referred to as inventive cathode active materials.

Particulate cathode active material according to the general formula Li₁₊ₓ(M²_{y}TM_{1-y})₍₁₋ₓ₎O₂ comprising secondary particles that are agglomerates from primary particles, wherein TM is nickel or TM contains Ni and at least one of Mn and Co, and wherein x is in the range of from zero to 0.2, and wherein y is in the range of from 0.001 to 0.01, and wherein M² is selected from Nb and Ta that is enriched at the crystallite surface of the primary particles and otherwise uniformly distributed in such cathode active material.

Said term “otherwise uniformly distributed” implies that M² is not enriched at the outer surface of the secondary particles of inventive cathode active material.

In one embodiment of the present invention, a compound of M² is enriched at the crystallite surface of the primary particles in form of a layer with an average thickness from 2 to 30 nm. This compound may include several compounds. Such compound(s) of M² that is enriched at the crystallite surface of the primary particles is selected from Nb₂O₅, Ta₂O₅, ZrO₂, TiO₂, LiNbO₃, LiTaO₃, Li₂ZrO₃, Li₄Ti₅O₁₂, Li₂TiO₃. Preferred are Nb₂O₅ and Ta₂O₅.

In one embodiment of the present invention, TM is a combination of metals according to general formula (I)

(NiₐCO_{b}Mn_{c})_{1-d}M¹_{d} (I)

with
a being in the range of from 0.6 to 0.99,
b being zero or in the range of from 0.01 to 0.2,
c being in the range of from zero to 0.2, and
d being in the range of from zero to 0.1,
M¹ is at least one of Al, Mg, Ti, Mo, W, and
a+b+c=1. Preferably, b+c>zero.

Some elements are ubiquitous. In the context of the present invention, traces of ubiquitous metals such as sodium, calcium, iron or zinc, as impurities will not be taken into account in the description of the present invention. Traces in this context will mean amounts of 0.02 mol-% or less, referring to the total metal content of TM.

In one embodiment of the present invention, inventive electrode active materials have an average particle diameter (D50) in the range of from 3 to 20 μm, preferably from 5 to 16 μm. The average particle diameter can be determined, e. g., by light scattering or LASER diffraction or electroacoustic spectroscopy. The particles are usually composed of agglomerates from primary particles, and the above particle diameter refers to the secondary particle diameter.

In one embodiment of the present invention, inventive electrode active materials have a span of the particle size distribution, defined by span=((D90)−D(10))/D(50), in the range of from 0.3 to 1.5, preferably either of from 0.3 to 0.5 or from 0.8 to 1.2. The particle size distribution can be determined, e. g., by light scattering or LASER diffraction or electroacoustic spectroscopy. The particles are usually composed of agglomerates from primary particles, and the above particle diameter refers to the secondary particle diameter

In one embodiment of the present invention, inventive precursors have a specific surface (BET) in the range of from 2 to 200 m²/g, preferably from 2 to 50 m²/g, determined by nitrogen adsorption, for example in accordance with to DIN-ISO 9277:2003-05.

A further aspect of the present invention relates to cathode, hereinafter also referred to as inventive cathodes.

Specifically, inventive cathodes contain
(A) at least one inventive electrode active material,
(B) carbon in electrically conductive form,
(C) a binder material, also referred to as binders or binders (C), and, preferably,
(D) a current collector.

In a preferred embodiment, inventive cathodes contain
(A) 80 to 98% by weight inventive electrode active material,
(B) 1 to 17% by weight of carbon,
(C) 1 to 15% by weight of binder material, percentages referring to the sum of (A), (B) and (C).

Cathodes according to the present invention can comprise further components. They can comprise a current collector, such as, but not limited to, an aluminum foil. They can further comprise conductive carbon and a binder.

Cathodes according to the present invention contain carbon in electrically conductive modification, in brief also referred to as carbon (B). Carbon (B) can be selected from soot, active carbon, carbon nanotubes, graphene, and graphite, and from combinations of at least two of the aforementioned.

Suitable binders (C) are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol-% of copolymerized ethylene and up to 50 mol-% of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol-% of copolymerized propylene and up to 50 mol-% of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder (C) is polybutadiene.

Other suitable binders (C) are selected from polyethylene oxide (PEO), cellulose, carboxymethylcellulose, polyimides and polyvinyl alcohol.

In one embodiment of the present invention, binder (C) is selected from those (co)polymers which have an average molecular weight M, in the range from 50,000 to 1,000,000 g/mol, preferably to 500,000 g/mol.

Binder (C) may be cross-linked or non-cross-linked (co)polymers.

In a particularly preferred embodiment of the present invention, binder (C) is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders (C) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Inventive cathodes may comprise 1 to 15% by weight of binder(s), referring to electrode active material. In other embodiments, inventive cathodes may comprise 0.1 up to less than 1% by weight of binder(s).

A further aspect of the present invention is a battery, containing at least one cathode comprising inventive electrode active material, carbon, and binder, at least one anode, and at least one electrolyte.

Embodiments of inventive cathodes have been described above in detail.

Said anode may contain at least one anode active material, such as carbon (graphite), TiO₂, lithium titanium oxide, silicon or tin. Said anode may additionally contain a current collector, for example a metal foil such as a copper foil.

Said electrolyte may comprise at least one non-aqueous solvent, at least one electrolyte salt and, optionally, additives.

Non-aqueous solvents for electrolytes can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol-% of one or more C₁-C₄-alkylene glycols. Polyalkylene glycols are preferably polyalkylene glycols having two methyl or ethyl end caps.

The molecular weight M, of suitable polyalkylene glycols and in particular suitable polyethylene glycols can be at least 400 g/mol.

The molecular weight M, of suitable polyalkylene glycols and in particular suitable polyethylene glycols can be up to 5 000 000 g/mol, preferably up to 2 000 000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds according to the general formulae (II) and (III)

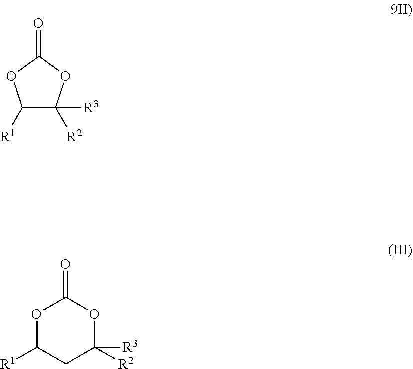

where R¹, R² and R³ can be identical or different and are selected from among hydrogen and C₁-C₄-alkyl, for example methyl, ethyl, n-propyl, isopropyl, n-butyl, isobutyl, sec-butyl and tertbutyl, with R² and R³ preferably not both being tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

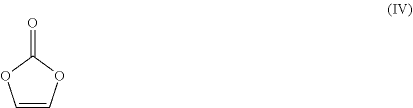

The solvent or solvents is/are preferably used in the water-free state, i.e. with a water content in the range from 1 ppm to 0.1% by weight, which can be determined, for example, by Karl-Fischer titration.

Electrolyte (C) further comprises at least one electrolyte salt. Suitable electrolyte salts are, in particular, lithium salts. Examples of suitable lithium salts are LiPF₆, LiBF₄, LiCIO₄, LiAsF₆, LiCF₃SO₃, LiC(CnF₂n+₁SO₂)₃, lithium imides such as LiN(CnF₂n+₁SO₂)₂, where n is an integer in the range from 1 to 20, LiN(SO₂F)₂, Li₂SiF₆, LiSbF₆, LiAlCl₄ and salts of the general formula (CnF₂n+₁SO₂)ₜYLi, where m is defined as follows:
t=1, when Y is selected from among oxygen and sulfur,
t=2, when Y is selected from among nitrogen and phosphorus, and
t=3, when Y is selected from among carbon and silicon.

Preferred electrolyte salts are selected from among LiC(CF₃SO₂)₃, LiN(CF₃SO₂)₂, LiPF₆, LiBF₄, LiCIO₄, with particular preference being given to LiPF₆ and LiN(CF₃SO₂)₂.

In an embodiment of the present invention, batteries according to the invention comprise one or more separators by means of which the electrodes are mechanically separated. Suitable separators are polymer films, in particular porous polymer films, which are unreactive toward metallic lithium. Particularly suitable materials for separators are polyolefins, in particular film-forming porous polyethylene and film-forming porous polypropylene.

Separators composed of polyolefin, in particular polyethylene or polypropylene, can have a porosity in the range from 35 to 45%. Suitable pore diameters are, for example, in the range from 30 to 500 nm.

In another embodiment of the present invention, separators can be selected from among PET nonwovens filled with inorganic particles. Such separators can have porosities in the range from 40 to 55%. Suitable pore diameters are, for example, in the range from 80 to 750 nm.

Batteries according to the invention further comprise a housing which can have any shape, for example cuboidal or the shape of a cylindrical disk or a cylindrical can. In one variant, a metal foil configured as a pouch is used as housing.

Batteries according to the invention display a good discharge behavior, for example at low temperatures (zero ° C. or below, for example down to −10° C. or even less), a very good discharge and cycling behavior.

Batteries according to the invention can comprise two or more electrochemical cells that combined with one another, for example can be connected in series or connected in parallel. Connection in series is preferred. In batteries according to the present invention, at least one of the electrochemical cells contains at least one cathode according to the invention. Preferably, in electrochemical cells according to the present invention, the majority of the electrochemical cells contains a cathode according to the present invention. Even more preferably, in batteries according to the present invention all the electrochemical cells contain cathodes according to the present invention.

The present invention further provides for the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The present invention is further illustrated by the following working examples.

Average particle diameters (D50) were determined by dynamic light scattering (“DLS”). Percentages are % by weight unless specifically noted otherwise.

### Tem Analysis:

The sample material was embedded in Epofix resin (Struers, Copenhagen, Denmark). Ultra-thin samples (˜100 nm) for Transmission Electron Microscopy (TEM) were prepared by ultramicrotomy and transferred to TEM sample carrier grids. The samples were imaged by TEM using Tecnai Osiris and Themis Z3.1 machines (Thermo-Fisher, Waltham, USA) operated at 200/300 keV under HAADF-STEM conditions. Chemical composition maps were acquired by energydispersive x-ray spectroscopy (EDXS) using a SuperX G2 detector. Images and elemental maps were evaluated using the Velox (Thermo-Fisher) as well as the Esprit (Bruker, Billerica, USA) software packages.

Ultramicrotomy usually does not create cross-sections through the primary particles but slices the secondary particles along the grain boundaries of the primary particles. EDS determines the chemical composition integrated over the whole thickness of the sample. Signal of the coating elements in the inner region of the primary crystallites is due to the surface coating on top and below the particle.

Step (a.1): A spherical Ni(OH)₂ precursor was obtained by combining aqueous nickel sulfate solution (1.65 mol/kg solution) with an aqueous 25 wt. % NaOH solution and using ammonia as complexation agent. The pH value was set at 12.6. The freshly precipitated Ni(OH)₂ was washed with water, sieved and dried at 120° C. for 12 hours. Subsequently, the freshly precipitated Ni(OH)₂ was poured into an alumina crucible and dried in a furnace under oxygen atmosphere (10 exchanges/h) at 500° C. for 3 hours using a heating rate of 3° C./min and a cooling rate of 10° C./min to obtain the precursor p-CAM.1 with a D50 of 6 μm.

Manufacture of a Comparative Cathode Active Material, C-CAM.1:

The dehydrated precursor p-CAM.1 was mixed with LiOH—H₂O in a molar ratio of Li:Ni of 1.01:1, poured into a alumina crucible and heated at 350° C. for 4 hours and 700° C. for 6 hours under oxygen atmosphere (10 exchanges/h) using a heating rate of 3° C./min. The resultant material was cooled to ambient temperature at a cooling rate of 10° C./min and subsequently sieved using a mesh size of 30 μm to obtain comparative material C-CAM.1 with a D50 of 6 μm.

Manufacture of an Inventive Material, CAM.2:

Step (b.2): Under a nitrogen atmosphere, 40 g of the precursor p-CAM.1 were placed in a beaker. 2.84 g niobium(V) ethoxide were dissolved in 10 ml dry ethanol. The resultant solution was added dropwise through a dropping funnel over 5 minutes at ambient temperature into the beaker until the precursor was soaked with liquid. No visible liquid film formed above the precursor. The resultant slurry was stirred in the beaker over a period of 30 minutes. The individual amounts of Nb and Ni were set to ensure a molar Ni:Nb ratio of 0.98:0.02.

Step (c.2): Subsequently, the ethanol was removed by heating the slurry for 6 hours at 120° C. at a pressure of 10 mbar to obtain p-CAM.2.

Steps (d.2) and (e.2): Precursor p-CAM.2 was mixed with LiOH—H₂O in a molar ratio of Li:(Ni+Nb) of 1.01:1, poured into an alumina crucible and heated at 350° C. for 4 hours and 700° C. for 6 hours under oxygen atmosphere (10 exchanges/h) with heating rate of 3° C./min and a cooling rate of 10° C./min. The material so obtained was subsequently sieved using a mesh size of 30 μm to obtain inventive cathode active material CAM.2.

Manufacture of an Inventive Material, CAM.3:

Step (b.3): Under a nitrogen atmosphere, 40 g of the precursor p-CAM.1 were placed in a beaker. 3.67 g tantalum(V) ethoxide were dissolved in 10 ml dry ethanol. The resultant solution was added dropwise through a dropping funnel over 5 minutes at ambient temperature into the beaker until the precursor was soaked with liquid. No visible liquid film formed above the precursor. The resultant slurry was stirred in the beaker over a period of 30 minutes. The individual amounts of Ta and Ni were set to ensure a molar Ni:Ta ratio of 0.98:0.02.

Step (c.3): Subsequently, the ethanol was removed by heating the slurry for 6 hours at 120° C. at a pressure of 10 mbar to obtain p-CAM.3.

Steps (d.3) and (e.3): Precursor p-CAM.3 was mixed with LiOH—H₂O in a molar ratio of Li:(Ni+Ta) of 1.01:1, poured into an alumina crucible and heated at 350° C. for 4 hours and 700° C. for 6 hours under oxygen atmosphere (10 exchanges/h) with heating rate of 3° C./min and a cooling rate of 10° C./min. The material so obtained was subsequently sieved using a mesh size of 30 μm to obtain inventive cathode active material CAM.3.

Step (a.4): A spherical precursor with the molar composition Ni:Co:Mn=91:4.5:4.5 was obtained by combining aqueous sulfate solutions of the respective transition metals in the corresponding ratios (1.65 mol/kg solution) with an aqueous 25 wt. % NaOH solution and using ammonia as complexation agent. The pH value was set at 11.7. The freshly precipitated material was washed with water, sieved and dried at 120° C. for 12 hours. Subsequently, the material was poured into an alumina crucible and dried in a furnace under oxygen atmosphere (10 exchanges/h) at 500° C. for 3 hours using a heating rate of 3° C./min and a cooling rate of 10° C./min to obtain the precursor p-CAM.4 with a D50 of 11 μm.

### Manufacture of an Inventive Material, CAM.4:

Step (b.4): Under a nitrogen atmosphere, 50 g of the precursor p-CAM.4 were placed in a beaker. 3.42 g niobium(V) ethoxide were dissolved in 10 g dry ethanol. The resultant solution was added dropwise through a dropping funnel over 5 minutes at ambient temperature into the beaker until the precursor was soaked with liquid. No visible liquid film formed above the precursor. The resultant slurry was stirred in the beaker over a period of 1-2 minutes. The individual amounts of Nb and (Ni:Co:Mn) were set to ensure a molar (Ni+Co+Mn):Nb ratio of 0.98:0.02.

Step (c.4): Subsequently, the ethanol was removed by drying the slurry for 24 h in vacuo at room temperature, followed by heating for 72 hours at 60° C. at a pressure of 10 mbar to obtain pCAM.5.

Steps (d.4) and (e.4): Precursor p-CAM.5 was mixed with LiOH—H₂O, Al₂O₃, ZrO₂ and TiO₂ in a molar ratio of Li:(Ni+Co+Mn+Nb) of 1.04:1, and Ni+Co+Mn+Nb):Al:Zr:Ti ratio of 0.974:0.02:0.003:0.003, poured into an alumina crucible and heated at 750° C. for 6 hours under oxygen atmosphere (10 exchanges/h) with a heating rate of 3° C./min and a cooling rate of 10° C./min. The material so obtained was subsequently sieved using a mesh size of 32 μm to obtain cathode active material CAM.4.

As shown by HAADF and EDS mapping, in CAM.2 and CAM.4 a niobium oxide was enriched at the crystallite surface of the primary particles and was otherwise uniformly distributed in such cathode active materials. As shown by HAADF and EDS mapping, in CAM.3 a tantalum oxide was enriched at the crystallite surface of the primary particles and was otherwise uniformly distributed in such cathode active materials.

### Manufacture of a Comparative Material, C-CAM.5:

Steps (d.5) and (e.5): Precursor p-CAM.4 was mixed with LiOH—H₂O, Al₂O₃, ZrO₂ and TiO₂ in a molar ratio of Li:(Ni+Co+Mn) of 1.04:1, and (Ni+Co+Mn):Al:Zr:Ti ratio of 0.974:0.02:0.003:0.003, poured into an alumina crucible and heated at 750° C. for 6 hours under oxygen atmosphere (10 exchanges/h) with a heating rate of 3° C./min and a cooling rate of 10° C./min. The material so obtained was subsequently sieved using a mesh size of 32 μm to obtain cathode active material C-CAM.5.

Electrode manufacture: Electrodes contained 94% respective CAM or C-CAM, 3% carbon black (Super C₆₅) and 3% binder (polyvinylidene fluoride, Solef 5130). Slurries were mixed in N-methyl-2-pyrrolidone and cast onto aluminum foil by doctor blade. After drying of the electrodes 6 h at 105° C. in vacuo, circular electrodes were punched, weighed and dried at 120° C. under vacuum for 12 hours before entering in an Ar filled glove box.

Half-Cell Electrochemical Measurements: Coin-type electrochemical cells (“coin half cells”), were assembled in an argon-filled glovebox. The positive 14 mm diameter (loading 8.0±0.5 mg cm⁻²) electrode was separated from the 0.58 thick Li foil by a glass fiber separator (Whatman GF/D). An amount of 95 μl of 1 M LiPF₆ in ethylene carbonate (EC): ethylmethyl carbonate (EMC), 3:7 by weight, was used as the electrolyte. Cells were galvanostatically cycled at a Maccor 4000 battery cycler between 3.1 and 4.3 V at room temperature by applying the following Crates until 70% of the initial discharge capacity is reached at a certain discharge step.

TABLE 1
Electrochemical test procedure of the coin half cells.

| | Charge | Discharge |
|---|---|---|
| Cycle 1 | 0.1 C | 0.1 C |
| Cycle 2 − 6 | 0.2 C + CV* | 0.2 C |
| Cycle 7 & 8 | 0.5 C + CV* | 0.5 C |
| Cycle 9 & 10 | 0.5 C + CV* | 2.0 C |
| Cycle 11 & 12 | 0.5 C + CV* | 3.0 C |
| Cycle 13 & 14 | 0.5 C + CV* | 0.5 C |

| | |
|---|---|
| Cycle 15 | Resistance measurement |

| | | |
|---|---|---|
| Cycle 16 − 40 | 0.5 C + CV* | 1.0 C |
| Cycle 41 + 42 | 0.5 C + CV* | 0.5 C |

| | |
|---|---|
| Cycle 43 | Resistance measurement |

| | | |
|---|---|---|
| Cycle 44 − 68 | 0.5 C + CV* | 1.0 C |
| Cycle 69 + 70 | 0.5 C + CV* | 0.5 C |

| | |
|---|---|
| Cycle 71 | Resistance measurement |

| | | |
|---|---|---|
| Cycle 72 − 96 | 0.5 C + CV* | 1.0 C |
| Cycle 97 + 98 | 0.5 C + CV* | 0.5 C |

| | |
|---|---|
| Cycle 99 | Resistance measurement |

| | | |
|---|---|---|
| Cycle 100 − 124 | 0.5 C + CV* | 1.0 C |
| Cycle 125 + 126 | 0.5 C + CV* | 0.5 C |

| | |
|---|---|
| Cycle 127 | Resistance measurement |

| | | |
|---|---|---|
| Cycle 128 − 152 | 0.5 C + CV* | 1.0 C |
| Cycle 153 + 154 | 0.5 C + CV* | 0.5 C |

| | |
|---|---|
| Cycle 155 | Resistance measurement |

| | | |
|---|---|---|
| Cycle 156 − 180 | 0.5 C + CV* | 1.0 C |
| Cycle 181 + 182 | 0.5 C + CV* | 0.5 C |

| | |
|---|---|
| Cycle 183 | Resistance measurement |

| | | |
|---|---|---|
| Cycle 184 − 208 | 0.5 C + CV* | 1.0 C |

After charging at the listed C-rates, all charge step except the first were finished by a constant voltage step (CV*) for 1 h, or until the current reached 0.02C.

During cycling, data points were collected every 1 minute or after voltage changes of at least 5 mV occurred. 4 electrochemical cells were assembled for each of the materials, the corresponding cycling profile, capacity and resistance was obtained by averaging the 4 cells.

During the resistance measurement (conducted every 25 cycles at 25° C.), the cell was charged at 0.2 C to reach 50% state of charge, relative to the previous discharge capacity. To equilibrate the cell, a 30 min open circuit step followed. Finally, a 2.5 C discharge current was applied for 30 s to measure the resistance. At the end of the current pulse, the cell was again equilibrated for 30 min in open circuit and further discharged at 0.2 C to 3.0 V.

To calculate the resistance, the voltage before applying the 2.5 C pulse current, VOs, and after 30 s of 2.5 C pulse current, V30 s, as well as the 2.5 C current value, (j in A), were taken. The resistance was calculated according to Eq. 3 (V: voltage, j: 2.5C pulse current).

R=(V0s−V30s)/j (Eq. 1)

TABLE 2
Electrochemical properties of comparative cathode
active material C-CAM.1 and inventive cathode
active materials CAM.2 and CAM.3.

| | C-CAM.1 | CAM.2 | CAM.3 |
|---|---|---|---|
| Discharge capacity in cycle 5 [mAh/g] | 203 | 182 | 173 |
| Discharge capacity in cycle 25 [mAh/g] | 163 | 169 | 161 |
| Discharge capacity in cycle 50 [mAh/g] | 139 | 163 | 145 |
| Discharge capacity in cycle 100 [mAh/g] | — | 147 | — |
| resistance in cycle # 15 [Ω] | 23 | 16 | 22 |
| resistance in cycle # 43 [Ω] | 36 | 22 | 20 |
| resistance in cycle # 99 [Ω] | — | 31 | — |

CAM.4 shows superior electrochemical properties over C-CAM.5.

1. A process for making an electrode active material, wherein said process comprises the following steps:
(a) providing an (oxy)hydroxide or oxide of TM, wherein TM is Ni or a combination of metals, wherein TM contains Ni and at least one of Mn and Co;
(b) treating said oxide or (oxy)hydroxide from step (a) with a non-aqueous or aqueous solution of a compound of M², wherein M² is selected from the group consisting of Ti, Zr, Nb and Ta;
(c) removing one or more solvents, thereby obtaining a solid residue;
(d) mixing the solid residue from step (c) with a source of lithium and, optionally, at least one compound of Ti or Al or Zr; and
(e) treating the mixture obtained from step (d) thermally at a temperature in a range of from 550 to 900° C.

2. A process according to claim 1, wherein TM is a combination of metals according to a general formula (I):
(NiₐCo_{b}Mn_{c})_{1-d}M_{d} (I)
with
a being in a range of from 0.6 to 0.99,
b being zero or in a range of from 0.01 to 0.2,
c being in a range of from zero to 0.2, and
d being in a range of from zero to 0.1,
wherein M is at least one of Al, Mg, Ti, Mo, and W, and
b+c>zero, and
a+b+c=1.

3. A process according to claim 1, wherein said (oxy)hydroxide provided in step (a) has a moisture content in a range of from 50 to 2,000 ppm by weight.

4. A process according to claim 1, wherein said compound of M² is selected from the group consisting of C₁-C₄-alkanolates.

5. A process according to claim 1, wherein M² is selected from the group consisting of Nb and Ta.

6. A process according to claim 1, wherein step (c) is performed by evaporation of the one or more solvents.

7. A process according to claim 1, wherein the solvent in step (cis selected from the group consisting of water and C₁-C₄-alkanols.

8. A process according to claim 1, wherein a molar ratio of M² to TM is in a range of from 1:100 to 1:1000.

9. A particulate cathode active material according to a general formula Li₁₊ₓ(M²_{y}TM_{1-y})₍₁₋ₓ₎O₂ comprising secondary particles that are agglomerates from primary particles,
wherein TM is Ni or TM contains Ni and at least one of Mn and Co,
wherein x is in a range of from zero to 0.2, and wherein y is in a range of from 0.001 to 0.01, and
wherein M² is selected from the group consisting of Zr, Nb and Ta that is enriched at a crystallite surface of the primary particles and otherwise uniformly distributed in such cathode active material.

10. A particulate cathode active material according to claim 9, wherein a compound of M² is enriched at the crystallite surface of the primary particles in form of a layer with an average thickness from 2 to 30 nm.

11. A particulate cathode active material according to claim 9, wherein M² is selected from the group consisting of Nb and Ta.

12. A particulate cathode active material according to claim 9, wherein TM is a combination of metals according to general formula (I):
(NiₐCo_{b}Mn_{c})_{1-d}M¹_{d} (I)
with
a being in a range of from 0.6 to 0.99,
b being zero or in a range of from 0.01 to 0.2,
c being in a range of from zero to 0.2, and
d being in a range of from zero to 0.1,
wherein M¹ is at least one of Al, Mg, Ti, Mo, and W, and
a+b+c=1.

13. A cathode containing:
(A) at least one particulate cathode active material according to claim 9,
(B) carbon in electrically conductive form, and
(C) a binder material.

14. A battery containing:
(1) at least one cathode according to claim 13,
(2) at least one anode, and
(3) at least one electrolyte.
